(19) United States
(12) Patent Application Publication
(10) Pub. No.: US 2009/0160351 A1
(43) Pub. Date: Jun. 25, 2009

(54) ELECTRIC DISCHARGE LIGHT-REGULATION MATCHING CIRCUIT

(75) Inventor: Chao-Chin YEH, Changhwa County (TW)

Correspondence Address: BROWDY AND NEIMARK, P.L.L.C.;624 NINTH STREET, NW, SUITE 300, WASHINGTON, DC, 20001-5303, US

(73) Assignee: Chuan Shih Industrial Co., Ltd, Tien Chung Township (TW)

(21) Appl. No.: 12/045,278

(22) Filed: Mar. 10, 2008

(30) Foreign Application Priority Data
Dec. 21, 2007 (TW) 96149360

(51) Int. Cl. H05B 41/16

(52) U.S. Cl. 315/275

(57) ABSTRACT

An inexpensive electric discharge light-regulation matching circuit for use with a standard light regulator to regulate the light of an electric discharge without causing flickering is disclosed to include a resonance unit, which comprises a first capacitor and a second capacitor connected in series and a first inductance connected in parallel to the first capacitor and second capacitor, a converter circuit connected to the resonance unit for converting an alternating current into a direct current, a half-bridge output unit, which comprises two electrically controlled switches connected in series to the converter unit with the respective control end respectively connected to a respective oscillation unit, and a voltage feedback unit, which is connected to the half-bridge output unit and the converter unit and comprises a second inductor, a third capacitor and a fourth capacitor that are connected in series. Further, the resonance frequency of the resonance unit is about a predetermined multiple of the working frequency of the half-bridge output unit.

### BACKGROUND OF THE INVENTION

1. Field of the Invention

The present invention relates to light regulation of an electric discharge lamp and more particularly, to an inexpensive electric discharge light-regulation matching circuit for use with a standard commercial light regulator to regulate the light of an electric discharge without causing flickering.

2. Description of the Related Art

A conventional commercial light regulation type electronic ballast for light-regulatable electric discharge lamp or fluorescent lamp tube generally utilizes a frequency modulation IC chip for light regulation control. However, a frequency modulation IC chip for this purpose is expensive. Therefore, an electronic ballast of this design is expensive, lowering its market acceptability.

Further, there are people propose to use a non-frequency modulation type IC chip with a light regulator for regulating the light of an electric discharge. However, this kind of non-frequency modulation type IC chip may be unable to maintain the current during regulation of the light, thereby causing flickering or burning of the electric discharge or light regulator, and the flickering of the light hurts the user's eyes.

### SUMMARY OF THE INVENTION

The present invention has been accomplished under the circumstances in view. It is therefore one object of the present invention to provide an electric discharge light-regulation matching circuit for use with a standard light regulator for regulating the light of an electric discharge, which maintains the current when regulating the light of the electric discharge, preventing the problem of flickering. It is another object of the present invention to provide an electric discharge light-regulation matching circuit for use with a standard light regulator for regulating the light of an electric discharge, which eliminates utilizes cheap elements to substitute for an expensive frequency modulation IC chip, lowering the cost and increasing market acceptability.

To achieve these and other objects of the present invention, the electric discharge light-regulation matching circuit comprises a resonance unit, which comprises a series circuit of a first capacitor and a second capacitor, and a first inductance connected in parallel to the series circuit of the first capacitor and the second capacitor, a converter circuit connected to the resonance unit and adapted for converting an alternating current into a direct current, a half-bridge output unit, which comprises two electrically controlled switches connected in series to the converter unit and the control ends of the electrically controlled switches being respectively connected to a respective oscillation unit, and a voltage feedback unit, which is connected to the half-bridge output unit and the converter unit, comprising a second inductor, a third inductor and a fourth capacitor that are connected in series, wherein the resonance frequency of the resonance unit is about a predetermined multiple of the working frequency of the half-bridge output unit. By means of the characteristic that the resonance frequency of the resonance unit is about a predetermined multiple of the working frequency of the half-bridge output unit, the invention eliminates the problem of flickering when regulating the light of the electric discharge. Further, the electric discharge light-regulation matching circuit utilizes relatively cheaper elements to substitute for an expensive frequency modulation IC chip, lowering the cost and increasing market acceptability.

### BRIEF DESCRIPTION OF THE DRAWINGS

FIG. 1 is a circuit diagram of an electric discharge light-regulation matching circuit in accordance with the present invention.

FIG. 2 is a frequency multiplication sequence chart according to the present invention.

FIG. 3 is a circuit diagram of a standard light regulator according to the present invention.

FIG. 4 is a schematic drawing showing the voltage waveforms of the conduction current and the input current according to the present invention.

### DETAILED DESCRIPTION OF THE INVENTION

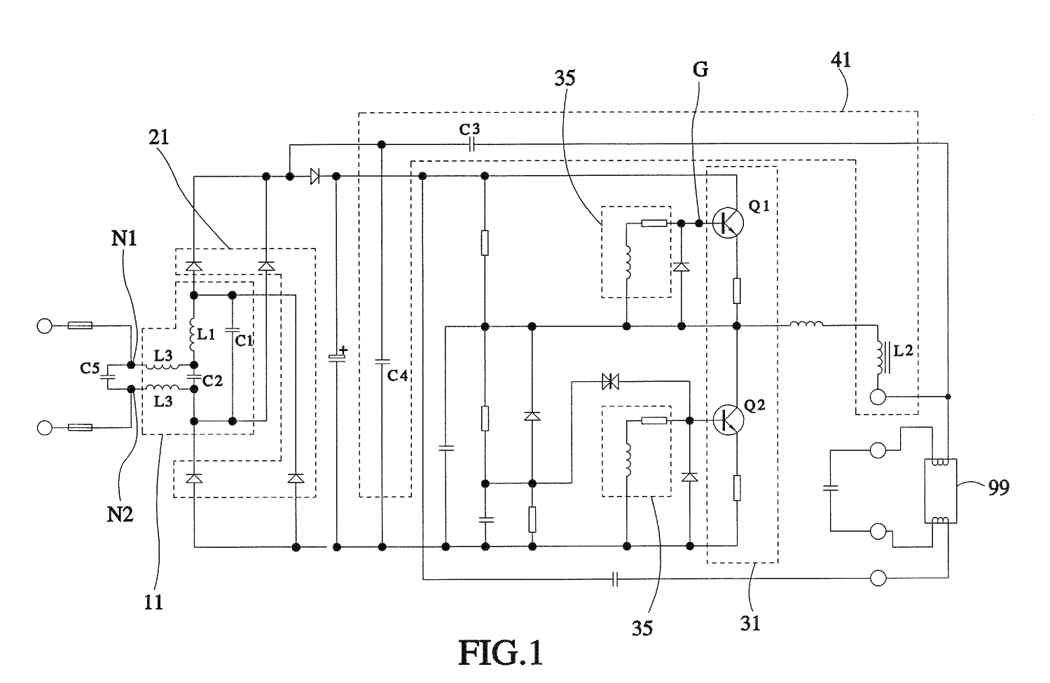

Referring to FIG. 1, an electric discharge light-regulation matching circuit 10 is adapted for use with a standard light regulator 51 to regulate the light intensity of an electric discharge lamp. The electric discharge light regulation matching circuit 10 is comprised of a resonance unit 11, a converter unit 21, a half-bridge output unit 31, and a voltage feedback unit 41.

The resonance unit 11 comprises a first capacitor C1 and a second capacitor C2 connected in series, and a first inductor L1 connected in parallel to the series of the first capacitor C1 and the second capacitor C2. The resonance unit 11 further comprises 2 third inductors L3. These 2 third inductors L3 each have one end respectively connected to the two opposite ends of the second capacitor C2, and the other end respectively connected to the two opposite ends of a fifth capacitor C5. The fifth capacitor C5 has its two opposite ends (terminals) N1, N2 for power input.

The converter unit 21 is connected to the resonance unit 11, and adapted for converting an alternating current into a direct current. According to the present preferred embodiment, the converter unit 21 is a bridge converter.

The half-bridge output unit 31 comprises two electrically controlled switches Q1, Q2 connected in series to the converter unit 21. Each of the two electrically controlled switches Q1, Q2 has a control end G. The control ends G of the two electrically controlled switches Q1, Q2 are respectively connected to a respective oscillation unit 35. Each of the two electrically controlled switches Q1, Q2 according to the present preferred embodiment is transistor. Each oscillation unit 35 is a RL (resistor-inductor) oscillation loop comprised of a resistor R and an inductor L that are connected in series.

The voltage feedback unit 41 is comprised of a second inductor L2, a third capacitor C3 and a fourth capacitor C4 that are connected in series. The voltage feedback unit 41 is connected to the half-bridge output unit 31 and the converter unit 21.

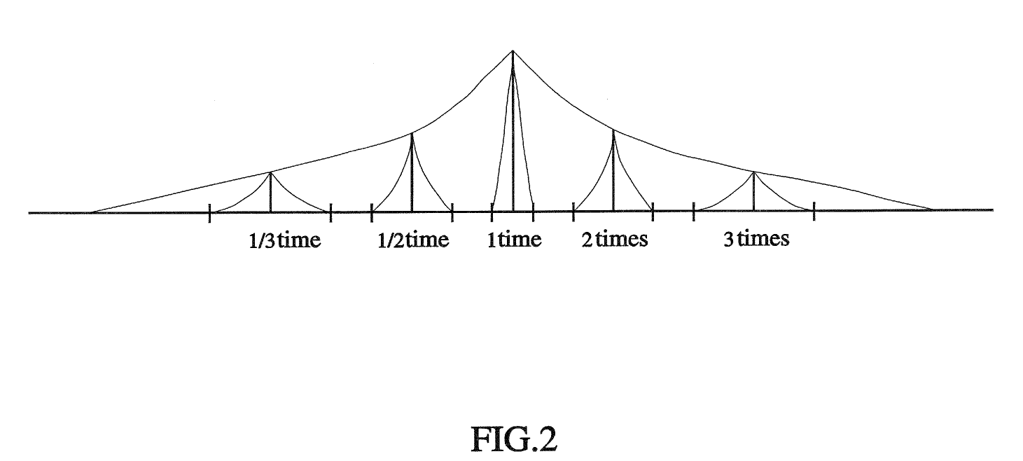

Further, the resonance frequency of the resonance unit 11 is a predetermined multiple of the working frequency of the half-bridge output unit 31. In detail, the resonance frequency of the resonance unit 11 is a multiple ±10% of the working frequency of the half-bridge output unit 31. The predetermined multiple can be a whole number multiple or 1/N multiple (N is a natural number), such as 1 time, 2 times, 3 times, ½ time, ⅓ time, ¼ time, . . . etc. According to the present preferred embodiment, the resonance frequency of the resonance unit 11 is ½ time ±10% of the working frequency of the half-bridge output unit 31. Under this condition, the working frequency of the half-bridge output unit 31 is about 55 KHz, and therefore the resonance frequency of the resonance unit 11 is about 27 KHz. The relationship of this frequency multiplication time sequence is shown in FIG. 2. The resonance frequency of the resonance unit 11 is obtained by means of regulating the values of the first capacitor C1, second capacitor C2 and first inductor L1 subject to the following formula (1).

$$f = \frac{1}{2 π \sqrt{LC}} = \frac{1}{2 π \sqrt{\frac{1}{\frac{1}{C 1} + \frac{1}{C 2}} + L 1}} \qquad formula ( 1 )$$

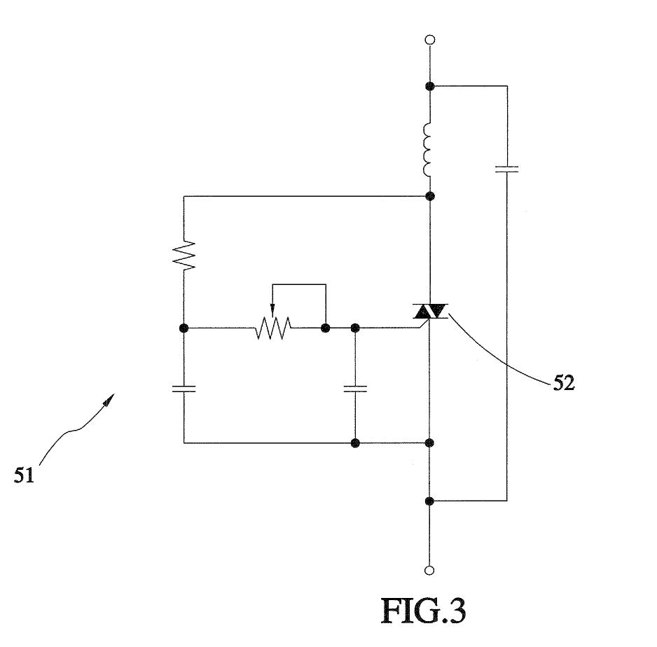

The electric discharge light regulation matching circuit 10 is used with a standard light regulator 51 (see FIG. 3) and an electric discharge lamp 99. The standard light regulator 51 is connected to the two power input terminals N1, N2 for regulating the brightness of the electric discharge 99. The electric discharge 99 is connected to the second inductor L2 and the converter unit 21. The circuit architecture of the standard light regulator 51 is shown in FIG. 3. Because that the standard light regulator 51 is the known art, no further detailed description regarding the composition and operation principle of the standard light regulator 51 is necessary.

Subject to the aforesaid structure and frequency setting, the resonance frequency of the resonance unit 11 is about ½ time of the working frequency of the half-bridge output unit 31, therefore the electric discharge light regulation matching circuit 10 prohibits the third capacitor C3 from feeding back the current to the two power input terminals N1, N2, preventing electromagnetic interference (EMI).

When the brightness of the lamp tube is adjusted to dark during regulation of the light, the input power is lowered gradually, causing “ringing” effect (the ringing effect will be described further). At this time, the storage electric energy of the first inductor L1 enables the standard light regulator 51 to obtain sufficient maintenance current, preventing current interruption of the internal TRIAC 52 of the standard light regulator 51 and eliminating the problem of flickering of the electric discharge 99. Further, the presence of DC impedance at the first inductor L1 effectively detains the ringing amplitude caused during regulation of the light, thereby restraining possible current interruption of the standard light regulator 51 and eliminating the problem of flickering during regulation of the light.

The occurrence of the aforesaid “ringing” effect is explained hereinafter. There is a resonance frequency at the inductance and capacitance at the input part of a regular circuit. The front current triggered by the light regulator contains a big amount of higher-order harmonics. These higher-order harmonics have therein an electric current of the same resonance frequency. They affect one another, causing oscillation.

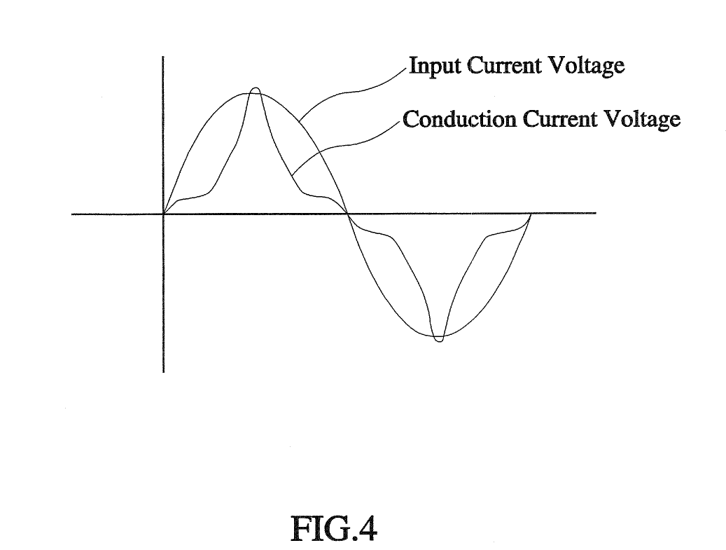

During input of power supply, the electric discharge 99 is started to produce a lamp tube voltage and current, obtaining a feedback voltage at the junction between the second inductor L2 and the electric discharge 99. The resonance produced subject to the multiplication relationship between the resonance frequency of the resonance unit 11 and the working frequency of the half-bridge output unit 31 increases the feedback voltage, thereby increasing the power factor. Therefore, conduction current exists in the whole half cycle of the standard light regulator 51. The voltage waveforms of the conduction current and the input current are shown in FIG. 4. Therefore, the conduction status is maintained without causing flickering.

Further, the discharging characteristic of the electric discharge 99 enables the lamp voltage of the lamp tube to be boosted rapidly when regulating the light from a dark status to a bright status, causing rise of the feedback voltage. Rising of the feedback voltage causes the increasing of the power factor, thereby eliminating the problem of flickering.

As stated above, the invention has the following features and advantages:

1. No flickering during regulation of the light: The invention utilizes the multiplication relationship of the resonance frequency between the resonance unit and the half-bridge unit to increase the power factor and maintain the current, preventing current interruption of the TRIAC of the connected light regulator and eliminating the problem of flickering.

2. Low cost: Because the invention utilizes the multiplication relationship of the resonance frequency between the resonance unit and the half-bridge unit to increase the power factor and maintain the current and to further eliminate the problem of flickering instead of the use of an expensive frequency modulation IC chip, the cost of the electric discharge light-regulation matching circuit is low. This low cost feature increases market acceptability of the electric discharge light-regulation matching circuit

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric discharge light-regulation matching circuit comprising:
a resonance unit, said resonance unit comprising a first capacitor and a second capacitor connected in series, and a first inductance connected in parallel to the series-connected combination of said first capacitor and said second capacitor;
a converter circuit connected to said resonance unit and adapted for converting an alternating current into a direct current;
a half-bridge output unit, said half-bridge output unit comprising two electrically controlled switches connected in series to said converter unit, each said electrically controlled switch comprising a control end, the control ends of said electrically controlled switches being respectively connected to a respective oscillation unit; and
a voltage feedback unit connected to said half-bridge output unit and said converter unit, said voltage feedback unit comprising a second inductor, a third capacitor and a fourth capacitor, said second inductor and said third capacitor and said fourth capacitor being connected in series;
wherein the resonance frequency of said resonance unit is about a predetermined multiple of the working frequency of said half-bridge output unit.

2. The electric discharge light-regulation matching circuit as claimed in claim 1, wherein the resonance frequency of said resonance unit is about a predetermined multiple ±10% of the working frequency of said half-bridge output unit.

3. The electric discharge light-regulation matching circuit as claimed in claim 2, wherein said predetermined multiple is a whole number multiple.

4. The electric discharge light-regulation matching circuit as claimed in claim 2, wherein said predetermined multiple is 1/N time, in which N is a natural number.

5. The electric discharge light-regulation matching circuit as claimed in claim 1, wherein said resonance unit further comprises 2 third inductors, the two third inductors each having one end thereof respectively connected to the two opposite ends of said second capacitor and an opposite end thereof respectively connected to the two opposite ends of said fifth capacitor.

6. The electric discharge light-regulation matching circuit as claimed in claim 1, wherein said converter unit is a bridge converter.

7. The electric discharge light-regulation matching circuit as claimed in claim 1, wherein each said electrically controlled switch is a transistor.

8. The electric discharge light-regulation matching circuit as claimed in claim 1, wherein each of the oscillation units to which the control ends of said electrically controlled switches are respectively connected is a RL (resistor-inductor) oscillation loop comprised of a resistor and an inductor that are connected in series.
